(19) United States
(12) Patent Application Publication
(10) Pub. No.: US 2013/0268458 A1
(43) Pub. Date: Oct. 10, 2013

(54) SYSTEM AND METHOD FOR IDENTIFYING RELEVANT ENTITIES

(71) Applicants: Filippo Maria ILARDI, New York, NY (US); David Andrew Blackwell, Asbury Park, NJ (US); Eric Rubin, Fairlawn, NJ (US)

(72) Inventors: Filippo Maria ILARDI, New York, NY (US); David Andrew Blackwell, Asbury Park, NJ (US); Eric Rubin, Fairlawn, NJ (US)

(21) Appl. No.: 13/439,315

(22) Filed: Apr. 4, 2012

(51) Int. Cl. G06Q 40/06; G06F 17/30

(52) U.S. Cl. 705/36 R; 707/749; 707/E17.033

(57) ABSTRACT

A system, method and non-transitory computer readable storage medium for storing data for a plurality of entities, the data including values for a plurality of characteristics of each of the entities, receiving an identification of one of the entities as a target entity, calculating a distance from the target entity to each other entity not identified as the target entity, wherein the distance is calculated based on the values of the characteristics for the target entity and each of the other entities and identifying a predetermined number of the other entities as relevant entities, wherein the identifying is based on the distance calculated for each of the other entities.

### BACKGROUND INFORMATION

There are many situations where it is useful to identify peer or similar entities for comparison. To provide one example, an investment organization may desire to compare the revenue generated by different brokers or financial advisors. It would be manifestly unfair to compare a particular broker to all other brokers because each broker has different characteristics. In such a situation, the investment organization will generally compare the broker of interest to peer brokers to determine how the broker of interest stacks up against such peer brokers.

However, the concept of peering or similarity analysis is very narrow in that it compares a very limited set of characteristics, usually a single characteristic, and bases the comparison on predefined ranges for such characteristics. To continue with the example started above, the peer brokers may be defined as brokers having the same level of experience, such as all brokers having 0-2 years of experience, brokers with 2-5 years experience, etc. While such a method will identify peers within this narrow range of a predefined characteristic, there is no guarantee that the brokers identified are truly the relevant brokers to which the broker of interest should be compared.

### SUMMARY OF THE EXEMPLARY EMBODIMENTS

An exemplary embodiment is directed at a method for storing data for a plurality of entities, the data including values for a plurality of characteristics of each of the entities and receiving an identification of one of the entities as a target entity. The method further calculating a distance from the target entity to each other entity not identified as the target entity, wherein the distance is calculated based on the values of the characteristics for the target entity and each of the other entities and identifying a predetermined number of the other entities as relevant entities, wherein the identifying is based on the distance calculated for each of the other entities.

A further exemplary embodiment is directed to a system having a non-transitory memory storing data for a plurality of entities, the data including values for a plurality of characteristics of each of the entities and a processor configured to calculate a distance from one of the entities identified as a target entity to each other entity not identified as the target entity, wherein the distance is calculated based on the values of the characteristics for the target entity and each of the other entities and further configured to identify a predetermined number of the other entities as relevant entities, wherein the identifying is based on the distance calculated for each of the other entities.

A further exemplary embodiment is directed to a non-transitory storage medium storing a set of instructions executable by a processor, wherein the instructions are operable to perform a method. The method is for storing data for a plurality of entities, the data including values for a plurality of characteristics of each of the entities, receiving an identification of one of the entities as a target entity, calculating a distance from the target entity to each other entity not identified as the target entity, wherein the distance is calculated based on the values of the characteristics for the target entity and each of the other entities and identifying a predetermined number of the other entities as relevant entities, wherein the identifying is based on the distance calculated for each of the other entities.

### BRIEF DESCRIPTION OF THE DRAWINGS

FIG. 1 shows an overview of an exemplary system for identifying relevant financial advisors (FA's) for comparison.

FIG. 2 shows an exemplary method for identifying relevant entities according to an exemplary embodiment.

### DETAIL DESCRIPTION OF THE EXEMPLARY EMBODIMENTS

The exemplary embodiments may be further understood with reference to the following description of the exemplary embodiments and the related appended drawings, wherein like elements are provided with the same reference numerals. The exemplary embodiments are related to systems and methods for identifying relevant entities for comparison. As described above, peer comparison based on predetermined ranges of one or a few characteristics has been determined to be too narrow an approach for selecting entities for comparison. The exemplary embodiments are directed to a novel approach for identifying relevant entities for comparison that accounts for a wide range of characteristics. A benefit of identifying relevant entities is to provide the entity of interest with insights into how they compare to the relevant entities in terms of key performance indicators (KPIs). KPIs may include any characteristic for which the entity of interest desires to be compared against the relevant entities and specific examples will be provided below. These KPI comparisons can help the entity of interest identify and prioritize areas for improvement.

Prior to describing the exemplary embodiments, it is noted that the term “entities” or its variants is used to describe any person, groups of persons, organization, corporation, etc. that may be used for comparison purposes. The example provided above concerning the broker or financial advisor clearly relates to an individual person. However, there may be other situations where the entity is a group of persons, such as a financial advisor team, a team of doctors, a team of lawyers, etc. that comprises multiple persons. In another example, the entity may be a corporation or other business association such as a financial services corporation, a telecommunications corporation, a pharmaceutical corporation, etc., where the corporation of interest will be compared to other relevant corporations.

The term “target entity” will be used to describe the entity of interest. That is, the target entity is the entity for which the comparison will be made. For example, in the financial advisor example, the target entity will be the financial advisor that desires to determine their performance against other relevant financial advisors.

In addition, the term “relevant entities” is used to describe those entities that are identified by the exemplary embodiments. This term is used to distinguish from peer or similar entities that, as described above, is considered to be limited to being based on specific ranges of characteristics. It is also used to distinguish from the entire group of entities. As would be understood in the example of the financial advisors, it would be unfair to compare the target financial advisor to the performance of all other financial advisors because these advisors have a wide range of characteristics. Thus, the target financial advisor is only interested in comparing their performance to those financial advisors that are considered to be relevant, i.e., those financial advisors having characteristics compatible with the target financial advisor. To provide a further example, if the target entity were a corporation having sales of $200M, peer corporations that may be used for comparison may be those corporations that have sales in the range of $100-$250M. However, as described above, such a manner of determining peers is too narrow. The exemplary embodiments provide a more effective manner of identifying relevant entities based on multiple characteristics. For example, relevant corporations for comparison may be determined based on gross sales, domestic sales, foreign sales, number of employees, type of business, number of sales people, R&D expenditures, etc. In addition, as will be described in greater detail below, the relevant entities are not determined based on ranges, but rather are based on an analysis of all the relevant characteristics.

It is noted that the exemplary embodiments are described with reference to a system that is used to compare financial advisors to continue with one of the examples provided above. However, those of skill in the art will understand that this is merely for descriptive purposes and the principles and functionality described herein for the exemplary embodiments may be applied to identifying any relevant entities for comparison.

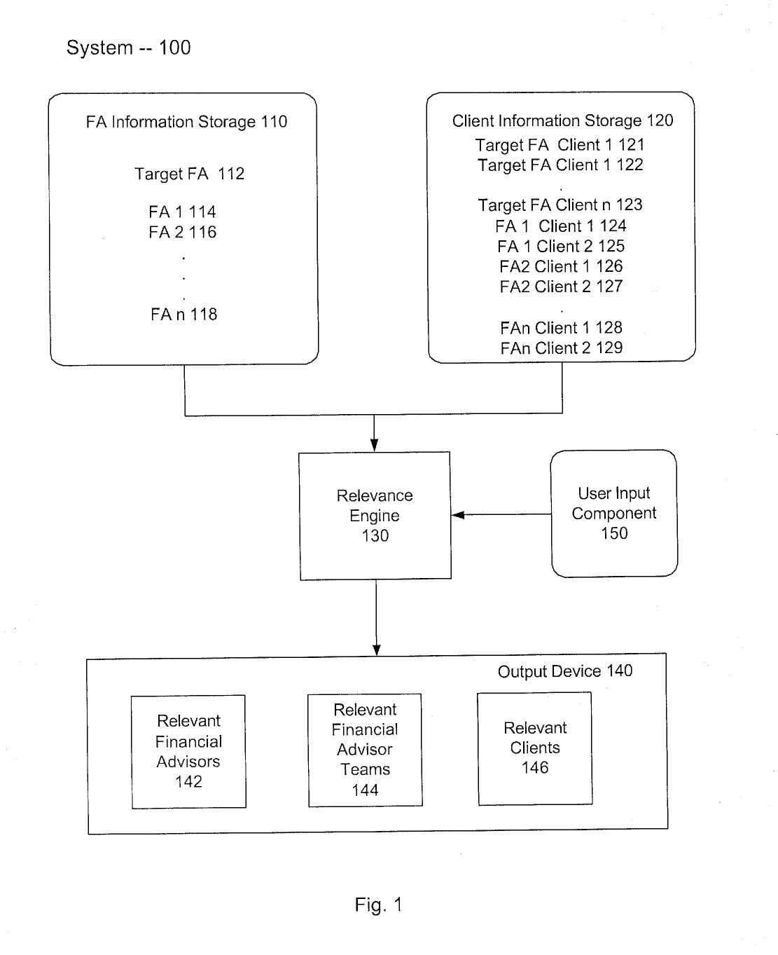

FIG. 1 shows an overview of an exemplary system 100 for identifying relevant financial advisors for comparison. The system 100 includes a financial advisor (FA) information storage 110 that stores data for each of the financial advisors. The financial advisors may be all financial advisors that are employed by a particular financial services firm, a subset thereof, financial advisors across the entire industry (e.g., financial advisors that are employed by different firms), or a subset thereof. In this example, a record for a target financial advisor 112 and other financial advisors 1, 2 . . . n (114, 116, 118) are shown. It should be understood that while the record 112 is identified as the target financial advisor 112, the system 100 is unaware of the actual target financial advisor until a user of the system 100 identifies the target financial advisor. Thus, in reality, all the records 112-118 correspond to an individual financial advisor without definition of a particular target financial advisor.

Each of these records 112-118 includes data for the corresponding financial advisor in a variety of information categories that may include, for example, assets under management, length of service, net new money rank, total number of clients, a breakdown in percentage between high net-worth clients and ultra-high net-worth clients, private wealth advisor accreditation, number of financial plans and the percentage of revenue the advisor generates from different product types (e.g., fixed income, equities, advisory discretionary, advisory non-discretionary, insurance, annuities and municipal bonds, etc.). Those skilled in the art will understand that these categories are only exemplary and any other categories of information that a user may find helpful in identifying relevant financial advisors may be stored for each of the financial advisors. Thus, each category of information and its corresponding data for the individual financial advisor will be considered the characteristics used to determine the relevant financial advisors.

The financial advisor information storage 110 may be any known device and/or method for storing data. For example, the financial advisor information storage 110 may be a database that is stored on a hard drive of a server device. Other examples of storage formats may include tables, arrays, etc. and other storage devices may include network storage devices, cloud storage devices, local storage devices, etc.

The financial advisor information storage 110 is populated with the relevant data, examples of which were described above. Those skilled in the art will understand that the financial advisor information storage 110 should be constantly updated to ensure that the data used to identify relevant financial advisors is the most up to date data. This updating may be automatic or manual. For example, the updating may be based on input from other systems such as systems which record executed trades by the financial advisor, a human resources system that includes the some of the above-described data for each of the financial advisors.

It is noted that in the exemplary embodiments, the financial advisor information storage 110 may also store data for financial advisor teams. That is, rather than storing data for an individual financial advisor, the data is for a group of professionals acting as a financial advisor team. In this situation, the relevant entities will not be individual financial advisors, but rather the financial advisor teams. The categories of information stored for the financial advisor teams will be similar to the above-described categories that are stored for the individual financial advisors. This feature is described to provide an example where the relevant entities will be a group of individuals, rather than an individual. Throughout the remainder of the description of the exemplary embodiments, it will generally be described with respect to a target individual financial advisor and the identification of relevant individual financial advisors for this target financial advisor. However, the exemplary methods and systems may be applied equally to the financial advisor teams.

The system 100 also includes client information storage 120 that stores data on the clients of the financial advisors (or teams). In this example, records 121-123 are shown for clients of the target financial advisor and records 124-129 are shown for clients of other financial advisors. Again, the system 100 is unaware of the target financial advisor until identification by a user. Thus, the client records 121-129 correspond to an individual client. The data stored for the clients may include categories of information such as asset values with the financial advisor, years with financial advisor, net new money rank, total number of orders, risk tolerance, presence of security-backed loan credit line, presence of a retirement plan and the percentage of assets in different product types (e.g., fixed income, equities, mutual funds, advisory programs, cash, etc.). As should be apparent from this description, there will be a relationship between the record of each client and the corresponding financial advisor, e.g., such as a relational database entry. As will be described in detail below, the identification of relevant entities may also include the identification of relevant clients.

The system 100 further includes a relevance engine 130 for identifying the relevant financial advisors, financial advisor teams and/or clients. The method for identifying relevant entities is based on an aggregated relevance across all the categories of information stored for the financial advisor, financial advisor team or client. Specifically, less relevance in one category of information may be offset by greater relevance in another category of information.

The relevance engine 130 will provide the results of the relevance calculations to an output device 140 for use by the user. The output device 140 may be, for example, a display device, a printer, etc. or may also serve as an input to a further process or system as will be described in greater detail below. As shown in FIG. 1, the output device 140 is illustrated as showing various outputs such as a relevant financial advisor output 142, a relevant financial advisor team output 144 and a relevant client output 146. Each of these outputs 142-146 will be described in greater detail below.

The system 100 also includes a user input component 150. The user input component 150 may be an actual physical component for providing user input such as a keyboard, mouse, touch screen, etc. or may also be a logical component such as a database or other memory that stores user preferences, etc. Throughout the below description of the exemplary embodiments, there will be numerous examples of optional or required user input or selections. Such user input or selections may be received via the user input component 150.

The operation of the system 100 will now be described. A user of the system 100 will identify the target financial advisor for which the relevance calculation should be performed. This identification may be in the form of the user logging onto the system 100 by way of entering a user name and password, via the user input component 150, which uniquely identifies the financial advisor user. In an alternative embodiment, a user may enter or select the target financial advisor or team via an entry screen or selection box. In a further exemplary embodiment, the system 100 does not require user entry in order for the calculations to commence. Instead, the calculations are commenced in batch mode, with output created in advance. Therefore, the user enters information to access output already produced by the system 100.

The relevance engine 130 will then commence the relevance calculation (or if running in batch mode, the relevance calculation will be commenced at the appropriate batch times) to determine the relevant financial advisors for the target financial advisor based on the categories of information stored for each of the financial advisors. The relevance calculation may be generally referred to as a distance calculation where each category of information has a defined weight. One exemplary formula for calculating the distance is defined as:

$$A D = \sqrt{\frac{{\sum }_{i = 1}^{n} Wi * {( {VREF}_{i} - {VREL}_{i} )}^{2}}{{\sum }_{i = 1}^{n} Wi}}$$

where,

AD is the abstract distance between two entities;

N is the number of categories of information selected for the model;

Wᵢ is the predefined weight of the i^{th} category of information;

VREFᵢ is the value of the i^{th} category of information for target entity; and

VRELᵢ is the value of the i^{th} category of information for relevant entity.

As stated above, the values for each of the categories of information need to be standardized for the distance calculation. For example, the net assets under management will be a dollar ($) value, while the length of service is a value based on months or years. There are other disparate types of values that will be stored in the various categories. Thus, to perform the distance calculation, these values need to be standardized so that they become valueless units that bear a relation to each other. For example, using the categories described above, the standardization cannot be merely excluding the units from the calculation because if a financial advisor has $10M net assets under management and 20 years length of service, merely excluding the ($) and years would cause the 10,000,000 number to swamp the 20 number. Thus, the values are standardized to bear a relation to each other.

In one exemplary embodiment, the standardization of numeric variables is conducted by subtracting a location measure from the variable and dividing by a scale measure. In the exemplary embodiment a location measure is mean and a scale of measure is Standard Deviation. Those skilled in the art will understand that other manners of standardizing the values may also be used. In addition, in some cases, there may be missing values or missing variables. In these cases, these values for these variables may be set to a value of zero.

As described above, each of the categories of information may have a predefined weight. This predefined weight may be a default weight assigned by the system administrator or designer or may also be assigned by the user of the system 100 and stored by the relevance engine 130 for use in the distance calculation.

It is noted that while the above stated that the identification of relevant entities is based on all the categories of stored information, the exemplary embodiments may be configurable such that a user may select a subset of the categories of stored information to use for the relevance calculation. This selection of a subset of the categories of information may include the selection of specific categories by a user such as through a check box or other similar type of user interface. The categories that are not checked will not be used in the relevance calculation. In another example, the user may be able to provide weighting for the various categories of information. For example, if the user does not want to use a particular category of information for the relevance calculation, this category may be assigned a zero (0) weight. Categories that the user decides are more important for the relevance calculation may be assigned a higher weighting.

The relevance engine 130 will store these selections for the user and use this stored data when performing the relevance calculation. It is noted that the relevance engine 130 may be provided with default settings such that the user is not required to make any selections, but may be constrained to use all the categories of information with each category having a weighting as assigned by the system administrator or designer.

The relevance engine 130 will identify the group of relevant financial advisors based on a pre-determined number of financial advisors having characteristics whose calculated distance is closest to the target financial advisor. In this exemplary embodiment, the pre-determined number is ten (10). However, this number is also settable by the user of the system 100 to include more or less financial advisors in the group of relevant financial advisors.

Those skilled in the art will understand that the above-described distance calculation formula is only exemplary and other types of distance calculations may also be used to determine the relevant financial advisors in accordance with the principles described herein. For example, another exemplary type of distance calculation is a City Block (Manhattan) distance calculation where the distance between two points is measured along axes at right angles. Any type of distance calculation that is used should account for relevance across all the selected categories of information where less relevance in one category of information may be offset by greater relevance in another category of information. A specific example based on a limited set of data stored in the categories for the financial advisors will be provided to further describe the principles encompassed by the distance calculation. In this example, the target advisor may have $10M assets under management, 5 years length of service and a net new money rank in the top 20% of financial advisors. The relevance engine 130, using the data stored in the financial advisor information storage 110 will compare this data with the corresponding data that is stored for all the other advisors using the distance calculation, e.g., either the distance calculation described above or another distance calculation. Based on this stored data, the relevance engine 130 will determine the ten (10) closest financial advisors as the relevant financial advisors. Thus, an advisor with $11M in assets under management, 12 years length of service and a net new money rank in the top 20% may be identified as a relevant financial advisor even though the length of service between the advisors is significantly different because the data across all the categories shows a closer correlation.

Once the relevance engine 130 identifies the relevant advisors, the relevance engine 130 may then also identify the relevant clients using the same methodology described above. A constraint on the relevant client calculation may be that only those clients of relevant financial advisors are evaluated to determine the relevant clients. That is, the identification of relevant clients for the target financial advisors is limited to the clients of the previously identified relevant financial advisors for the target financial advisor. However, this constraint is an optional constraint, the relevant clients may include any clients and are not limited to only those clients of relevant financial advisors. This exemplary constraint is merely provided to show that various constraints or conditions may be placed upon the data to result in a particular data set, e.g., list of relevant clients, but other conditions and/or constraints or no conditions and/or constraints may also be used.

The relevance engine 130 will determine the relevant clients based on the data stored in the client information storage 120 by comparing the data stored for each client of the target financial advisor and the data stored for each of the identified relevant financial advisors. This identification is based on a similar distance calculation as described above and a pre-determined number of clients are then identified as the relevant clients.

The relevance engine 130 will then output, via the output device 140, the relevant financial advisors 142 or teams 144 and the relevant clients 146. As described above, these outputs may be used as is or may also be used to perform additional calculations and/or analysis of the data that is stored for the target financial advisor and clients and the relevant financial advisors and clients. For example, the outputs 142-146 may be used as input into a further system that calculates the KPIs that may include, for example, net new money, revenue, ROA, product penetration, client acquisition and retention. These KPI comparisons can help a financial advisor or financial advisor team identify and prioritize areas for practice development. It is noted that while the KPIs are described herein, these are merely one example of the type of additional calculations and/or analysis that may be performed using the identified relevant entities. The KPI calculation is not a required calculation of the exemplary embodiments.

Another potential benefit of identifying relevance financial advisors is to enable advisors to know who their peers are so they can “network” with them to share best practices. Thus, in this situation, no additional calculations are required, i.e., the identification of the relevant financial advisors 142 is the output that the user of the system 100 desires.

Similarly, a potential benefit of identifying relevant clients 146 is to provide financial advisors or teams insights into how their clients compare to the relevant clients in terms of KPIs such as net new money, revenue, ROA, product penetration, and share of wallet. These KPI comparisons can help a financial advisor or team inform client development strategies and new business proposals.

In addition to the listing of the relevant entities, it is possible that the outputs 142-144 include additional information such as the measure of the absolute and/or relative distances to the target entity. For example, the absolute distances between each of the relevant entities may be output in the order of relevance. In a further example, the relative distances of each of the relevant entities to the target entity and to each of the other relevant entities may be output.

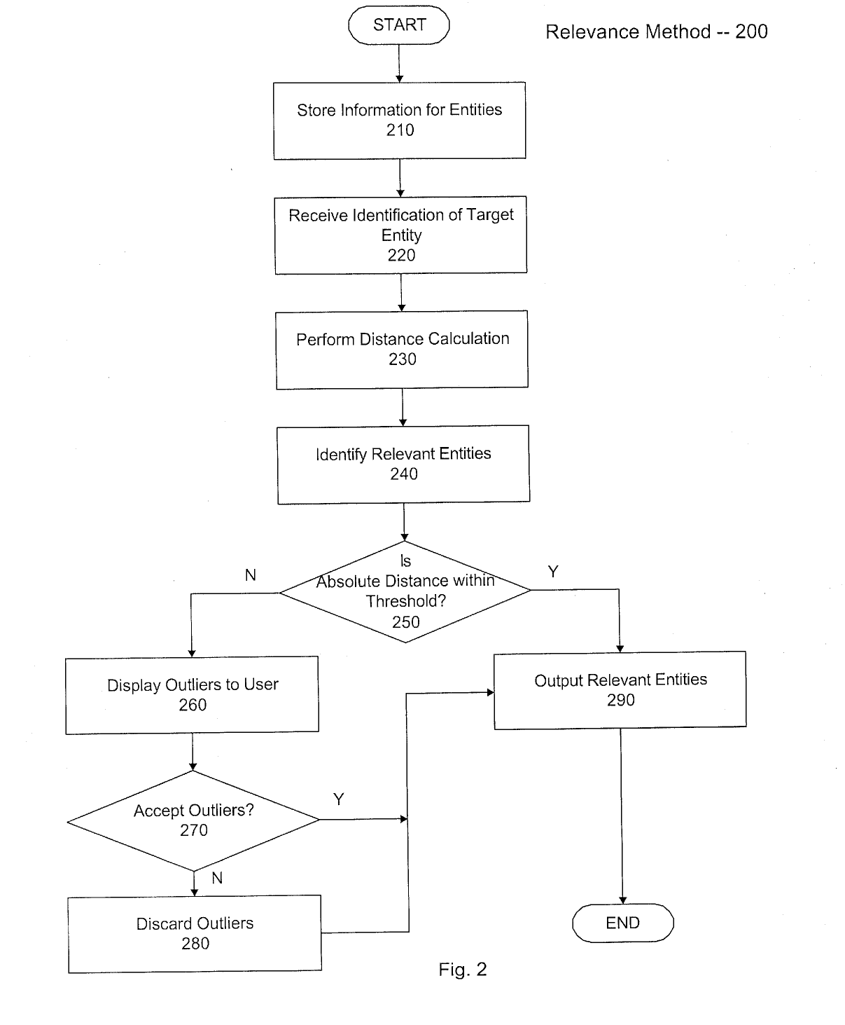

FIG. 2 shows an exemplary method 200 for identifying relevant entities. The method 200 will be described with reference to the system 100, but those skilled in the art will understand that the method 200 may be employed by other systems. In step 210, information for all the entities is stored. This information includes the data for each of the categories or characteristics of the entities that will be used to identify the relevant entities. Referring to the system 100 of FIG. 1, this may include the data stored in the financial advisor information storage 110 and/or the data stored in the client information storage 120.

In step 220, the identification of the target entity is received. As described above, the target entity is the entity for which the comparison is to be provided. For example, in the system 100, the relevance engine 130 may receive a user input via the user input component 150 identifying the financial advisor user of the system 100. This user input may be in the form of a user name and password that uniquely identifies the user as the target entity. As also described above, this step is optional in that the calculations may be performed in batch mode and the user may then log into the system 100 to obtain the results of the previously run batch calculations. Thus, the step 220 of identifying the target entity for which the calculations should be run, may be performed later as identifying the target entity for which the results of the previously run calculations should be provided.

In step 230, the relevance engine 130 performs the distance calculations. As described above, the distance calculation calculates a distance from the target entity to each of the other entities for which data is stored. The distance is based on a multitude of the stored characteristics for the target entity and the other entities. Each characteristic may have its own weighting in the distance calculation in the form of a default weighting or a user specified weighting. Exemplary criteria and principles for performing the distance calculation were provided above, including one exemplary formula for a distance calculation.

In step 240, the relevance engine 130 identifies the relevant entities based on the distance calculation performed in step 230. Specifically, a predetermined number of the closest entities to the target entities are identified as the relevant entities. For example, the predetermined number may be ten (10) entities. Again, the number of entities that are identified as relevant may be selectable by the user.

The next step 250 may be an optional step where the relevance engine 130 determines whether the identified relevant entities meet a predetermined threshold of closeness to the target entity. That is, as described above, the relevance engine 130 determines the distance from the target entity to each of the other entities (step 230) and then identifies the predetermined number of closest entities as the relevant entities (step 240). However, this identification of the relevant entities based on the predetermined number of entities is a relative determination. Thus, in the example of ten (10) relevant entities, it is possible that there could be an exemplary scenario where the first eight relevant entities are within a certain absolute distance from the target entity, while the ninth and tenth relevant entities are orders of magnitude farther away from the target entity than the eighth relevant entity. This would mean that while the first through eighth relevant entities are relatively close to the target entities in terms of the absolute distance, the ninth and tenth entities are relatively far away from the target entities. Thus, the optional step 250 allows the relevance engine to determine whether the absolute distance from each of the identified relevant entities is within a predetermined threshold of the target entity. Similar to the other steps, the predetermined absolute distance threshold may be a default setting or may be set by the user via the user interface 150.

If the absolute distance is not within the predetermined threshold these relevant entities may be designated outliers and the method may continue to step 260 where the relevance engine 130 displays the outliers to the user, via relevance output 140. This display of the outliers may include the absolute distance from the target entity and the relative distance from the target entity and/or the other identified relevant entities that are within the predetermined threshold. In response to this display, the user may decide whether to accept or reject the outliers in step 270. If the user rejects the outliers as being too far from the target entity, the outliers are discarded from the relevant entities in step 280.

Otherwise, if the user accepts the outliers in step 270 or if there are no outliers identified in step 250, the method proceeds to step 290 where the relevance engine 130 outputs the relevant entities via relevance output 140. It is also noted that step 250-280 are optional and if not employed by the system 100, the method 200 would proceed from the identifying step 240 directly to the outputting step 290.

It is noted that there may also be a corresponding optional steps for steps 250-280 where instead of identifying outliers as described above, the method 200 identifies entities that were not included as relevant entities, but are relatively close to those entities that are identified as relevant entities. To provide a specific example, it may be considered that the ten (10) closest entities (based on the distance calculation) are identified as the relevant entities. However, it may be that the eleventh and twelfth closest entities are relatively close to the identified relevant entities (e.g., within 2% of the distance from the target entity as the tenth identified relevant entity). In such a case, the method 200 may identify these next closest entities with their relative distance to the target entity and allow the user to select as to whether to include more than the predetermined number of entities in the identified relevant entities because the entities that just missed being identified as relevant are closely corresponding to the identified relevant entities.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the calculation engine may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

1. A computer-implemented method for identifying entities relevant to a target entity, the method being implemented in a computer system comprising a processor, the method comprising:
storing data, in a non-transitory memory of the computer system, for a plurality of entities comprising at least a first entity, a second entity, and a third entity, the data including a plurality of values for a respective plurality of characteristics of at least the first entity, the second entity, and the third entity;
receiving, by the computer system, an identification of the first entity as the target entity;
calculating, by the computer system, a distance from the target entity to at least each of the second entity and the third entity of the plurality of entities, wherein the distance between the target entity and the second entity is calculated based on differences in the values of at least a first characteristic and a second characteristic of the plurality of characteristics for the target entity and the second entity and the distance between the target entity and the third entity is calculated based on differences in values of at least the first characteristic and the second characteristic of the plurality of characteristics for the target entity and the third entity; and
identifying, by the computer system, a predetermined number of the plurality of entities as one or more relevant entities based on the distances calculated.

2. The method of claim 1, wherein calculating the distance between the target entity and the second entity comprises:
weighting at least the first characteristic and a second characteristic of the plurality of characteristics.

3. The method of claim 1, wherein the calculating the distance between the target entity and the second entity comprises:
standardizing at least a first value of the first characteristic for the target entity and a second value of the first characteristic for the second entity.

4. The method of claim 1, further comprising:
receiving by the computer system, a selection of a subset of the plurality of characteristics, wherein the distance between the target entity and the second entity is calculated based on differences in values of the subset of the characteristics for the target entity and the second entity and the distance between the target entity and the third entity is calculated based on differences in values of the subset of the characteristics for the target entity and the third entity.

5. The method of claim 2, wherein one or more of the plurality of weights associated with the plurality of characteristics comprise default values.

6. (canceled)

7. The method of claim 1, further comprising:
determining one or more key performance indicators based on the stored data of one or more of: the target entity or one or more of the identified relevant entities.

8. The method of claim 1, further comprising:
displaying, by the computer system, one of an absolute distance or a relative distance to between the target entity and the identified relevant entities; and
receiving, by the computer system, a selection from a user comprising information regarding whether to remove any of the identified relevant entities as relevant entities.

9. The method of claim 1, further comprising:
displaying, by the computer system, one of an absolute distance or a relative distance between the target entity a number of next closest other entities not identified as relevant entities; and
receiving, by the computer system, a selection from a user comprising information regarding whether to include any of the next closest other entities as identified relevant entities.

10. A system for identifying entities relevant to a target entity, the system comprising:
a non-transitory memory storing data for a plurality of entities comprising at least a first entity, a second entity, and a third entity, the data including a plurality of values for a respective plurality of characteristics of at least the first entity, the second entity, and the third entity; and
a processor configured to:
receive an identification of the first entity as the target entity;
calculate a distance from the target entity to at least each of the second entity and the third entity of the plurality of entities, wherein the distance between the target entity and the second entity is calculated based on differences in values of at least a first characteristic and a second characteristic of the plurality of characteristics for the target entity and the second entity and the distance between the target entity and the third entity is calculated based on differences in values of at least the first characteristic and the second characteristic of the plurality of characteristics for the target entity and the third entity; and
identify a predetermined number of the plurality of entities as one or more relevant entities based on the distances calculated.

11. The system of claim 10, further comprising:
a user input component configured to receive the identification of the target entity from a user.

12. The system of claim 10, wherein the processor is configured to:
determine one or more key performance indicators based on the stored data of one or more of: the target entity or one or more of the identified relevant entities.

13. The system of claim 10, wherein the processor is configured to calculate the distance by: weighting at least the first characteristic and the second characteristic of the plurality of characteristic.

14. The system of claim 10, wherein the processor is configured to calculate the distance by: standardizing at least a first value of the first characteristic for the target entity and a second value of the first characteristic for the second entity.

15. (canceled)

16. The system of claim 10, wherein the plurality of entities are financial advisors and the plurality of characteristics comprise one or more of: assets under management, length of service, net new money rank, total number of clients, a breakdown in percentage between high net-worth clients and ultra-high net-worth clients, private wealth advisor accreditation, number of financial plans, or the percentage of revenue the financial advisor generates from different product types.

17. The system of claim 10, wherein the plurality of entities are clients of financial advisors and the plurality of characteristics comprise one or more of: asset values with one of the financial advisors, years with one of the financial advisors, net new money rank, total number of orders, risk tolerance, presence of security-backed loan credit line, presence of a retirement plan, or the percentage of assets in different product types.

18. A non-transitory storage medium storing a set of instructions executable by a processor, wherein the processor may execute the instructions to cause a computer system to perform a method for identifying entities relevant to a target entity, the method comprising:
storing data for a plurality of entities comprising at least a first entity, a second entity, and a third entity, the data including a plurality of values for a respective plurality of characteristics of at least the first entity, the second entity, and the third entity;
receiving an identification of one of the first entity as the target entity;
calculating a distance from the target entity to at least each of the second entity and the third entity of the plurality of entities, wherein the distance between the target entity and the second entity is calculated based on differences in values of at least a first characteristic and a second characteristic of the plurality of characteristics for the target entity and the second entity and the distance between the target entity and the third entity is calculated based on differences in values of at least the first characteristic and the second characteristic of the plurality of characteristics for the target entity and the third entity; and
identifying a predetermined number of the plurality of entities as one or more relevant entities based on the distances calculated.

19. The method of claim 1, wherein the plurality of entities are financial advisors and the plurality of characteristics comprise one or more of: assets under management, length of service, net new money rank, total number of clients, a breakdown in percentage between high net-worth clients and ultra-high net-worth clients, private wealth advisor accreditation, number of financial plans, or the percentage of revenue the financial advisor generates from different product types.

20. The method of claim 1, further comprising:
calculating, by the computer system, a distance from each of the plurality of entities to each other of the plurality of entities, wherein the distance between the first entity and the second entity is calculated based on differences in values of at least the first characteristic and the second characteristic of the plurality of characteristics for the first entity and the second entity and the distance between the first entity and the third entity is calculated based on differences in values of at least the first characteristic and the second characteristic of the plurality of characteristics for the first entity and the third entity;
storing the calculated distances;
receiving, by the computer system, an identification of the first entity as the target entity; and
identifying, by the computer system, a predetermined number of the plurality of entities as one or more relevant entities based on the stored calculated distances between the target entity and the other entities of the plurality of entities.

21. The system of claim 10, wherein the processor is configured to:
calculate a distance from each of the plurality of entities to each other of the plurality of entities, wherein the distance between the first entity and the second entity is calculated based on differences in values of at least the first characteristic and the second characteristic of the plurality of characteristics for the first entity and the second entity and the distance between the first entity and the third entity is calculated based on differences in values of at least the first characteristic and the second characteristic of the plurality of characteristics for the first entity and the third entity;
store the calculated distances;
receive, an identification of the first entity as the target entity; and
identify a predetermined number of the plurality of entities as one or more relevant entities based on the stored calculated distances between the target entity and the other entities of the plurality of entities.

22. The method of claim 1, wherein calculating the distance between the target entity and the second entity comprises:
storing a plurality of weights associated with the respective plurality of characteristics;
determining a first difference in value of the first characteristic for the target entity and the second entity;
calculating a first weighted difference by applying a weight associated with the first characteristic to the first difference;
determining a second difference in value of at least the second characteristic for the target entity and the second entity;
calculating a second weighted difference by applying a weight associated with the second characteristic to the second difference; and
calculating the distance based on at least the first weighted difference and the second weighted difference.
